(19) United States
(12) Patent Application Publication
(10) Pub. No.: US 2007/0189592 A1
(43) Pub. Date: Aug. 16, 2007

(54) Method for determination of order numbers of spatial elements associated with spatial points

(76) Inventor: Robert Schneider, Rosstal (DE)

Correspondence Address: HARNESS, DICKEY & PIERCE, P.L.C., P.O.BOX 8910, RESTON, VA, 20195, US

(21) Appl. No.: 11/602,251

(22) Filed: Nov. 21, 2006

(30) Foreign Application Priority Data
Nov. 22, 2005 (DE) 10 2005 055 664.7

(51) Int. Cl. G06K 9/00; G06K 9/36

(52) U.S. Cl. 382/128; 382/276; 382/154

(57) ABSTRACT

In order to calculate order numbers of voxels in which the sampling points of a slice are located, a method is proposed. The method, in at least one embodiment, includes calculating the order numbers of the relevant voxels in one pass, and storing these in a cohesive memory area. This makes it possible to prevent constriction of the pipeline of a processor which may be used to carry out the method, and to dispense with the time-consuming instructions for transmission of data between registers of different size.

### PRIORITY STATEMENT

The present application hereby claims priority under 35 U.S.C. §119 on German patent application number DE 10 2005 055 664.7 filed Nov. 22, 2005, the entire contents of which is hereby incorporated herein by reference.

### FIELD

The invention generally relates to a method for determination of order numbers of spatial elements. For example, it may relate to a method for determination of order numbers of spatial elements which are associated with spatial points, in which spatial coordinates of the spatial points are loaded in a register in a processor, and the order numbers are determined from the spatial coordinates by computational operations in the processor.

### BACKGROUND

Methods are used when processing is being carried out with discrete volume data. The volume data is in this case in the form of discrete volume elements, with which so-called voxels are associated. The volume data may be in both scalar and vector form. In the case of a three-dimensional model of a body part, created with the aid of computed tomography, the volume data may, for example, relate to the density of the body part being examined. If a slice through the pre-dimensional model is intended to be created, the volume data must be interpolated onto the grid of the slice. In order to allow the interpolation to be carried out, the order numbers of the volume elements must be determined by means of which the slice passes through the volume data.

The order numbers may be one-dimensional or multi-dimensional indices, keywords with alphanumeric characters, physical addresses or the like. Fundamentally, this relates to the problem of determining those volume elements in which a set of spatial points is located. The set of spatial points may lie on a curve, on a two-dimensional surface or else in a volume area.

Until now, the associated spatial element or voxel in which the spatial point is located has been determined for each spatial point, with the interpolation being carried out immediately after this. Scalar determination of the relevant spatial element and the interpolation which is carried out immediately after this, require a large amount of computation effort, since the calculation must be carried out in serial form for a large number spatial points.

Modern processors for workstation computers are, however, also able to carry out vector operations in order to process image data. In the case of vector operations, data is processed in parallel by way of a single instruction (SIMD=single instruction multiple data). However, the use of vector operations for interpolation is dependent on the data which is required to carry out the interpolation being located linearly in the memory and, of course, this is not the case when the interpolation process is being carried out on a set of spatial points located along an undefined curve.

Thus, in general, scalar operations for reorganization or gathering of data generally have to be inserted between the determination of the indices and the actual interpolation. In this case, it is admittedly in principle possible to use instructions which allow direct data interchange between the registers for vector operations and the scalar registers. However, instructions such as these are highly time-consuming, so that the time recovered by the use of vector operations is lost again.

### SUMMARY

In at least one embodiment of the invention, a method is specified for determination of the order numbers of spatial elements associated with specific spatial points, which allows the determined order numbers to be determined and processed as efficiently as possible.

The method, in at least one embodiment, is distinguished in that the calculated order numbers are temporarily stored in a linear memory area of a memory unit before further processing from the registers of the processor.

In this context, the expression a linear memory area includes a memory area which can be written or read from incrementally on one physical level. Furthermore, in particular, the expression a memory unit means a random access data memory (=RAM).

Although the buffer-storage of data in a linear memory area is associated with a certain time penalty, it is, however, generally possible to write to the linear memory area at high speed, and the additionally required time can be recovered with the aid of vector operations during the preceding or subsequent calculations, so that, overall, considerably less time is required for the processing of the spatial data. In particular, previous calculations with vector operations can write to the memory area, and subsequent calculations can access linearly stored data with vector operations.

In consequence, subsequent or previous calculations can also carry out vector operations, by which a large number of data items can be processed in parallel. Thus, overall, buffer storage in a linear memory area saves time in comparison to a purely scalar method or a method in which data is interchanged between scalar registers and vector registers.

In one example embodiment, the storage of the order numbers in the linear memory area is optimized for access with the aid of vector operations. This allows the data to be read from the linear memory area, and to be written to the linear memory area, at high speed.

In one further example embodiment, the linear memory area is filled with a large amount of data in terms of order numbers than that which can be read or written by individual vector operations. In this case, the memory accesses, which are carried out with a different width, can be carried out with an adequate time interval in order to avoid an event occurring which is known to those skilled in the art by the expression “fast forward violation”, and which leads to the processor being constricted, since it is necessary to ensure that no collisions occur between the operations which access the same memory area with a different width.

One particularly high-speed embodiment of the method is obtained by using a vector operation for calculation of the order numbers, and by using vector operations to write the calculated order numbers to the linear memory area.

The vector operations can be used particularly efficiently for calculation of the order numbers if the spatial points lie on a configurable curve, and the spatial points are associated with uniformly separated parameter values.

### BRIEF DESCRIPTION OF THE DRAWINGS

Further characteristics and advantages of the invention will become evident from the following description, in which example embodiments of the invention are explained in detail with reference to the attached drawings, in which:

FIG. 1 shows a block diagram of a medical apparatus;

FIG. 2 shows a two-dimensional spatial area which passes along a straight line; and

FIG. 3 shows a block diagram of a microprocessor.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

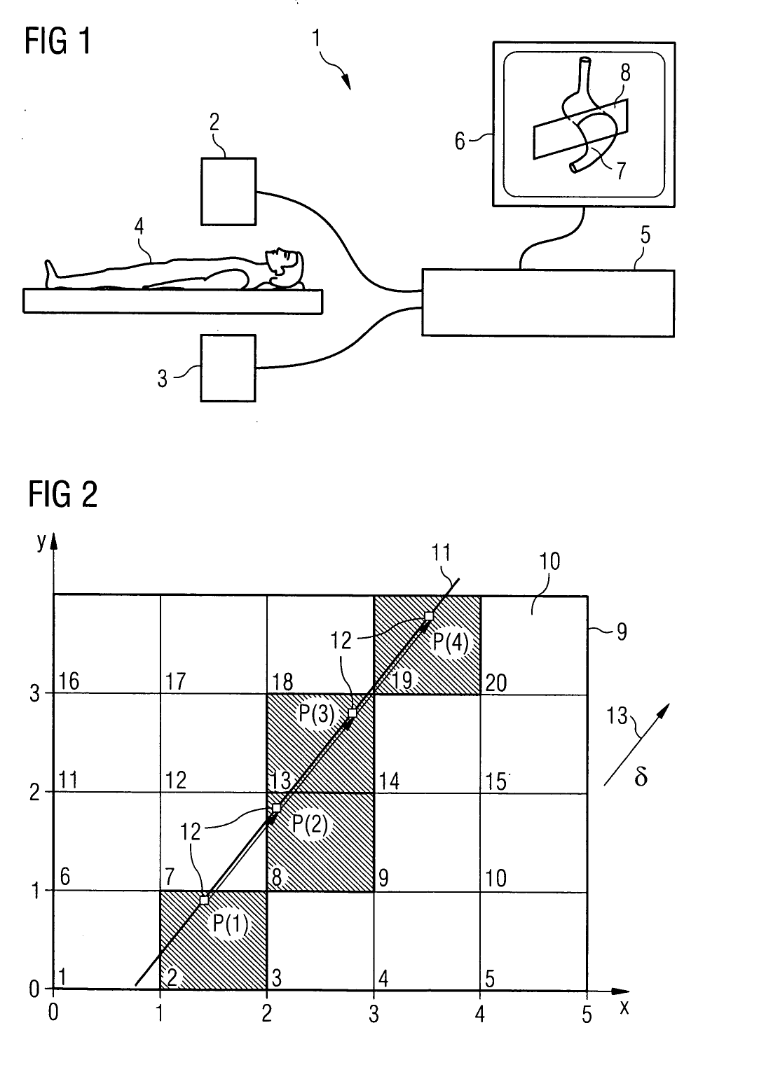

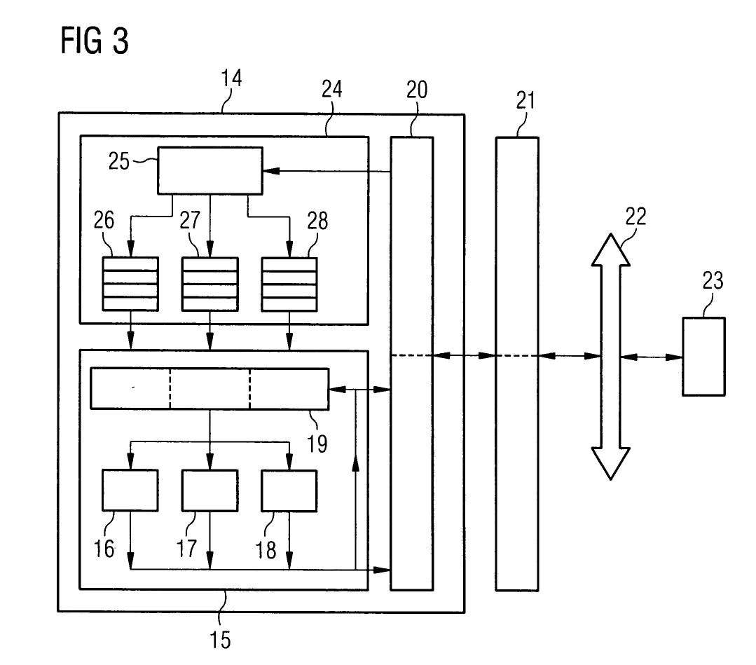

FIG. 1 shows a medical diagnosis appliance, for example an appliance for magnetic resonance imaging. A medical diagnosis appliance such as this includes, inter alia, a microwave transmitter 2 and a microwave receiver 3, as well as an apparatus (which is not illustrated in FIG. 1) for production of a powerful magnetic field, which passes through the body of a patient 4 who is to be examined. Three-dimensional models of the interior of the body of the patient 4 can be created by means of signals which are received by the microwave receiver 3 after a microwave pulse has been transmitted by the microwave transmitter 2. A computer 5 which displays the results on a screen 6 is normally used for signal evaluation. In FIG. 1, the screen 6 shows a three-dimensional representation of an internal organ 7, from which a slice view is intended to be created along a slice plane 8. By way of example, this is based on the use of a method which is known to those skilled in the art by the expression multiplanar reconstruction (=MPR).

For the purposes of this method, the volume data which represents the organ 7 must be interpolated in order to allow production of the volume data on the grid of the slice plane 8.

FIG. 2 shows a two-dimensional volume 9 which is composed of twenty voxels 10. A slice line 11 is placed through the volume 9, and has four sample points 12 within the volume 9. The sample points 12 are annotated P(1) to P(4) in FIG. 2. The aim is to determine the volume data at the sample points 12 by interpolation of volume data associated with the sample points 12. For this purpose, it is necessary to determine the voxels 10 which are shaded in FIG. 2, and in which the sample points 12 are located. In particular, the aim is to determine the index M (which in the present case passes from the number 1 to number 20) of the relevant voxels 10.

The index M can be calculated by way of a vector operation, if the sample points 12 are each shifted to a fixed spatial interval 13.

In principle, it will be possible to interpolate the volume data by first of all determining the associated voxel 10 at a sample point 12 and by then interpolating to the sample point 12 from the volume data associated with the voxel 10. However, the performance of a procedure such as this is not good since it does not exhaust the capabilities of modern processors.

The architecture of a processor 14 will therefore be considered in the following text.

The processor 14 has an arithmetic and logic unit 15 which has a computation device 16 for integer operations, a computation device 17 for floating-point operations, and a computation device 18 for vector operations. Furthermore, the arithmetic and logic unit 15 has registers 19, from which the computation devices 16 to 18 read data, and to which the computation devices 16 to 18 can write back data. In order to buffer the data flow, the processor 14 furthermore has a first-order cache 20, which interchanges data with a second-order cache 21. The cache 21 is connected to a bus system 22, which is also connected to a main memory 23. Instructions contained in the first-order cache 20 can be retrieved by an instruction unit 24.

Inter alia, the instruction unit 24 has an instruction decoder 25, which converts the instructions to microcode and allocates the microcode to a pipeline 26, 27 or 28. The microcode contained in the pipelines 26 to 28 is used to control the arithmetic and logic unit 15, in particular the computation devices 16 to 18. It should be noted that the pipelines 26 to 28 may also be associated with the arithmetic and logic unit 15.

The computation device 18 for vector operations is of particular importance for processing of image data. This is because this computation device can be used to read and process a plurality of data items, which have been stored for one pixel in the register 19, by way of a single instruction from the register 19. Thus, in principle, it is possible to execute the sample points 12 from FIG. 2 with the aid of computation operations. However, this is dependent on the data to be processed being located linearly in the memory, in particular in the second-order cache 21, or in the main memory 23.

This is, of course, not the case when the sample points 12 lie along an undefined curve through the volume 9. The index M of the sample points 12 is thus determined in such a way that the indices lie in a cohesive data array after completion of the index determination process. If this data array has been completely filled with index data, the indices can be read and processed by subsequent program modules with the aid of a vector operation or scalar operations.

In the situation illustrated in FIG. 2, the coordinates of the voxels 10 in which the sample points 12 are located are determined first of all, and the index M is calculated from the coordinates of the voxels 10, and is stored in a data array. In the present case, the coordinates of the voxels 10 would result for the pairs (1, 0) (2, 1), (2, 2), (3, 3). The index M=5·y+x+1 can be calculated from the coordinates. The index values M would be stored in a data array A1 with the values 2, 8, 13, 19.

The index values can then be used in subsequent operations to carry out the interpolation with the aid of vector operations.

The indices can also be determined by vector operations, if the sample points 12 can be produced by shifting through the same spatial interval 13.

This will be illustrated with reference to the following program example. This program can be used to calculate the indices of the voxels in a three-dimensional volume with the aid of SIMD in the form of SSE2 (=Streaming SIMD Extension 2).

The three-dimensional volume includes D slices, with each slice having B voxels in the x direction and C voxels in the y direction. Each slice thus represents a data array whose size is B×C. Each voxel is thus defined by the index N of the relevant slice, and the index M within the slice.

The situation will now be considered in which a beam φ passes through the volume and sample points 12 are located at a regular interval δ on this beam. Then, for the discrete sample points 12: φ=α+n·δ where n=1, . . . , 4·S and δ=(δx, δy, δz). The total number of discrete sample points 12 is in this case 4·S. The aim is to determine the index N of the slice and the index M within the slice at the discrete sample points 12. In the following text, the size of the voxels 10 in the volume is intended to be (1, 1, 1). If the voxels 10 in that volume are not of this size, affine imaging can be carried out, so that the volume can be imaged onto a volume in which the voxels 10 are of this size. This affine imaging must likewise be applied to the sample points 12 on the beam φ.

Using fixed-point arithmetic, each sample point 12 can be defined by integer numbers. For example as a 32-bit integer number, with 16 bits being used for the digits before the decimal point, and 16 bits for those after the decimal point. Four integer numbers of 32 bits each fit into one SSE2 register, for which reason four discrete sample points 12 are in each case handled in parallel. First of all, the coordinates x, y, z of the voxels 10 are determined in the volume for each sample point 12. The coordinates would define those voxels 10 if the volume were to be stored in a three-dimensional data array. The index N of the slices and the index M within the slice are then obtained from the coordinates x, y, z using N=z, M=y·B+x.

The sampling points 12 are handled in blocks of four. In this case, the four values for the index N and the four values for the index M are calculated and stored. The indices N and M can be written to a single, joint, data array A1. The entries in the data array A1 would then be as follows: M1, M2, M3, M4, N1, N2, N3, N4, M5, M6, M7, M8, NS, N6, N7, N8, . . . , M(S−3), M(S−2), M(S−1), M(S), N(S−3), N(S−2), N(S−1), N(S)

In principle, it is also possible to distribute the indices N and M over two data arrays. However, this would require more time since it is not possible to write cohesively to the data array.

One method which calculates the indices N and M and stores them in the data array A1 could appear as follows:

The first four discrete sample points 12 are assumed to be stored in the registers aStartVector128iX, aStartVector128iY, aStartVector128iZ with each register respectively containing the x, y or z value of the four discrete sample points 12 using fixed-point arithmetic.

A move is made from one block of four sample points 12 to the next block by addition of the registers add_ddx_full, add_ddy_full and add_ddz_full, which each contain the components of the distance vector δ:
add_ddx_full=(4*δx, 4*δx, 4*δx, 4*δx),
add_ddy_full=(4*δy, 4*δy, 4*δy, 4*δy),
add_ddz_full=(4*δz, 4*δz, 4*δz, 4*δz),

Program code which uses the Intel Compiler Intrinsics can then appear as follows:

void fillAddressCache( int aNumberBlocks_in) {
_m128i ddx_full, ddy_full, ddz_full;
_m128i ddx_shift, ddy_shift, ddz_shift;
_m128i aMemLine = _mm_setl_epi32(B);
_m128i aResXY;
ddx_full = aStartVector128iX;
ddy_full = aStartVector128iY;
ddz_full = aStartVector128iZ;
for (int i=0; i<aNumberBlocks_in; i++)
{

ddx_shift = _mm_srai_epi32(ddx_full,16);
ddy_shift = _mm_srai_epi32(ddy_full,16);
ddz_shift = _mm_srai_epi32(ddz_full,16);
aResXY = _mm_madd_epi16(ddy_shift,aMemLine);
ddx_full = _mm_add_epi32(ddx_full,add_ddx_full);
ddy_full = _mm_add_epi32(ddy_full,add_ddy_full);
ddz_full = _mm_add_epi32(ddz_full,add_ddz_full);
Al[2*i] = _mm_add_epi32(aResXY,ddx_shift);
Al[2*i+1] = ddz_shift;
}

return;
}

In the fillAddressCache method, the x, y and z values of the sample points are first of all initialized with the aid of the start vector aStartVector128i. This is done by value assignment to the variables ddx_full to ddz_full. A shift operation through 16 bits is then carried out in the following loop in order to determine the integer components of the x, y and z components of the sample points 12.

In the subsequent calculation of aResXY, the result of the shift operation with respect to the coordinate y is multiplied by the number of voxels contained in one row.

The coordinates ddx_full to ddz_full are then incremented for the next pass through the loop.

Finally, the indices N and M are calculated and are stored in the elements A1[2i] and A1[2i+1] of the data array A1.

It should be noted that SSE2 registers 19 can be written most efficiently to the second-order cache 21 or to the main memory 23 when the addresses of the memory area are aligned to 16 bytes (=16 bytes aligned), since the SSE2 registers have a width of 128-bits. The data array A1 is therefore aligned to 16 bytes.

It should also be noted that the implementation of the index determination process with the aid of SIMD becomes more advantageous the more complex the index calculation is. In the situation in which the volume slices are located linearly one behind the other in one data array in the memory and each voxel is defined uniquely by a single index M, the index M, for example, would have to be determined using the formula M=zBC+yB+x. More than one multiplication operation is required in this case in order to calculate the index M.

It should also be noted that the example embodiments described here represent comparatively simple special cases. In many applications, the calculation of the index from the coordinates of the voxels may be considerably more complex. For example, two-dimensional image processing frequently makes use of so-called cache tiles, in which the data is stored in blocks. In this case, the index calculation is considerably more complex. Nevertheless, even in this case, the indices can be calculated with the aid of SIMD in a corresponding manner to the exemplary embodiments described above, and can be stored in one data array A1. The indices can then be used, for example for interpolation of volume data, in subsequent processing steps.

Finally, the sample points 12 do not necessarily need to progress incrementally from one another by addition of a distance vector δ. It is in fact sufficient for the sample points 12 to be located on a configurable curve and for the sample points 12 to be associated with the parameter values with uniform intervals. One example of a curve such as this is a polynominal spline curve.

Furthermore, the volume may also be a binary volume. In this case, each voxel has a flag which can assume the value true or false. A binary volume such as this is used, for example, for binary masks. In this case, eight flags are generally combined with in each case one bit to form one byte. The indices to be calculated are then the index of the byte and the bit value within the byte, which are associated with one specific voxel. In this case as well, the calculated index values are once again stored in a data array A1.

Apart from this, care should be taken to ensure that the fast forward violation event does not occur during the changeover from the calculation of the indices to the subsequent processing of the indices. This event can occur when using processors such as the Intel Pentium 4 and the AMD Athlon processor.

The fast forward violation event occurs, for example, in the following procedure: first of all, the index data produced during the index calculation is written with the aid of scalar operations to a memory area which is as large as a register 19 which can be used for SIMD. This memory area may, for example, be located in the second-order cache 21. Immediately following this, this memory area is loaded into the register 19 intended for SIMD for further processing with the aid of vector operations.

However, this procedure violates the fast forward strategy of the processors 1 which are suitable for SIMD. This is because this strategy does not allow small registers 19 to be written to a memory area which is loaded again immediately after this from a large register 19. If this is nonetheless done, this leads to a constriction of the pipeline 28 (=pipeline stall), since it is necessary to ensure that all of the instructions which are placed in the large register 19 before being read have also actually been carried out and ended.

The fast forward violation event also occurs when writing is taking place from large registers 19 to a memory area and, following this, small registers 19 are used to read from the previously filled memory area.

These effects are also the reason why the calculation of the indices with the aid of SIMD takes longer when the calculation of the indices using SIMD is carried out first and the calculated indices are written to a memory area which is then read again, immediately after this, with the aid of small registers 19.

A further aspect to be considered is that it is time-consuming to read the calculated indices from the registers 19 which are provided for SIMD. This is because the instructions which can be used to transfer the contents of registers 19 which are intended for SIMD to scalar registers 19 are very slow. The time penalty is so great that this generally results in scarcely any speed advantage over purely scalar calculation of the indices.

If the calculation of the indices is carried out in one pass, the results of the calculation are buffer-stored in the data array A1, and the subsequent operations are then carried out only in further passes, this avoids the two problems that have been described. This makes it possible to circumvent not only the time-consuming reading of the registers 19 which are intended for SIMD, by way of time-consuming instructions, but also the fast forward violation.

In order to avoid the fast forward violation, it is necessary not to write to a memory area which is then read from again immediately with a different register width than was used for the writing process. The data array A1 must therefore be made sufficiently large that a sufficiently long time has passed before the data is read from the data array A1, so that no fast forward violation occurs. In order to avoid a fast forward violation, it is therefore necessary to ensure that the data array A1 is sufficiently large.

If a large set of discrete sample points 12 is being handled, there is no need to choose the data array A1 to be so large that all of the discrete sample points are determined in one pass. In fact, it is recommended that the set of sample points 12 be subdivided into small subsets, and that the index calculation in each case be carried out for each subset, with the subsequent processing steps immediately following the index determination process. In consequence, the size of the data array A1 is kept small.

Conversely, a data array A1 which includes only four sample points 12 (S=1) is too small to allow it to be used efficiently. Specifically, with this size, there is a risk of a fast forward violation being initiated when the calculated index data is read from the data array A1 at a later time. However, this depends on the implementation of the index calculation. It is also dependent on how the compiler translates the implemented code to assembler code. It is thus advantageous for more than four discrete sample points 12 (S>1) to be handled in one pass, for example all of the sample points which are located along a beam, or the sample points of the block of an image or of a volume. This ensures that the implementation has no influence on the time required for index calculation. Furthermore, this reliably avoids a fast forward violation.

The index calculation performance is very good as a result of the avoidance of the fast forward violation and dispensing with time-consuming SIMD instructions for transferring the calculated index data from relatively large registers to relatively small registers. The more complex the index calculation is and the greater the number of indices which can be handled at the same time by SIMD, the greater is the efficiency gain.

The multipass strategy described here, in which the index calculation and the subsequent use of the indices take place in a plurality of separate passes, allows the optimized code to be used relatively easily again for the index calculation. If, for example, the way in which the volume data is stored is modified, only the algorithm which calculates the indices need generally be adapted. Thus, in the above example, only the fillAddressCache method would have to be adapted. If the index data is first located in the data array A1, the index data can be processed further without any problems. There is therefore generally no need to likewise adapt the processing process which is built on it.

Since the index calculation is not embedded in the code which is used to carry out further method steps, the code for index calculation can be optimized by the programmer, and can be reused for a large number of methods which build on it.

In this case, the nature of the subsequent processes is irrelevant. For example, this may include different types of interpolation, for example bilinear, trilinear or tricubic interpolation. The subsequent processes are, however, not just restricted to interpolations, but the subsequent processes may relate to any desired processes which operate with volume data. Examples of these are the finding of binary values in a binary volume mask or the determination of the value or of the values in an octree volume structure.

Examples of the method described here for index calculation is not just suitable for three-dimensional volumes but can be used just as well for one-dimensional data arrays, two-dimensional images or, in general, for n-dimensional volumes. However, it is advantageous for the volume to be composed of voxels which are of the same size.

Finally, it should be noted that the data array A1 should always be written to and read from in a linear form, since this is the quickest way to store data in a RAM, for example the second-order cache 21. In addition, it is then possible to read virtually exclusively from the cache in the subsequent method steps. The linear processing of the data array A1 is optimal for the processors 1, since the Cache-Hardware-Prefetching can then operate optimally.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for determination of order numbers of spatial elements associated with spatial points, the method comprising:
loading spatial coordinates of the spatial points in a register in a processor; and
calculating the order numbers from the loaded spatial coordinates by computational operations in the processor, calculated order numbers being temporarily stored in a linear memory area of a memory unit before further processing from the register of the processor.

2. The method as claimed in claim 1, wherein a data array is stored in the linear memory area.

3. The method as claimed in claim 1, wherein the order numbers, stored in the memory area, are storable by way of a single storage instruction from the register for vector operations.

4. The method as claimed in claim 1, wherein the calculation of the order numbers is carried out for more spatial points than are loadable into the register for vector operations by a single load instruction.

5. The method as claimed in claim 1, wherein the calculation of the order numbers is carried out for more spatial points than are required to avoid pipeline constriction of the processor.

6. The method as claimed in claim 1, wherein the calculation of the order numbers is carried out with the aid of vector operations.

7. The method as claimed in claim 6, wherein the spatial points lie on a configurable curve and are associated with uniformly separated parameter values.

8. The method as claimed in claim 7, wherein the spatial points are each shifted through a spatial interval which remains the same.

9. The method as claimed in claim 6, wherein the vector operations are carried out using SIMD.

10. The method as claimed in claim 1, wherein the order numbers are calculated from spatial points which are embedded in a three-dimensional volume.

11. The method as claimed in claim 1, wherein spatial coordinates of the spatial elements are first calculated from the spatial coordinates of the spatial points, and the order numbers of the spatial elements are then calculated from the spatial coordinates of the spatial elements.

12. The method as claimed in claim 1, wherein indices of the spatial elements are calculated.

13. The method as claimed in claim 1, wherein the order numbers of spatial points are calculated for a multiplanar reconstruction of medical volume data.

14. An apparatus for evaluation of data, comprising:
means for loading spatial coordinates of the spatial points in a register in a processor; and
means for calculating the order numbers from the loaded spatial coordinates by computational operations in the processor, calculated order numbers being temporarily stored in a linear memory area of a memory unit before further processing from the register of the processor.

15. A computer program product for evaluation of data, including program code for, when executed on a computer device, carrying out a method as claimed in claim 1.

16. The method as claimed in claim 2, wherein the order numbers, stored in the memory area, are storable by way of a single storage instruction from the register for vector operations.

17. The method as claimed in claim 3, wherein the calculation of the order numbers is carried out for more spatial points than are loadable into the register for vector operations by a single load instruction.

18. The method as claimed in claim 7, wherein the vector operations are carried out using SIMD.

19. The method as claimed in claim 8, wherein the vector operations are carried out using SIMD.

20. A computer readable medium for evaluation of data, including program code for, when executed on a computer device, carrying out a method as claimed in claim 1.
